(19) United States
(12) Patent Application Publication
(10) Pub. No.: US 2014/0290374 A1
(43) Pub. Date: Oct. 2, 2014

(54) Apparatus to Monitor Flow Assurance Properties in Conduits

(71) Applicant: David V. Brower, Houston, TX (US)

(72) Inventor: David V. Brower, Houston, TX (US)

(21) Appl. No.: 13/852,896

(22) Filed: Mar. 28, 2013

(51) Int. Cl. G01L 11/02

(52) U.S. Cl. CPC G01L 11/025
USPC 73/705

(57) ABSTRACT

A combination of sensors are strategically placed along a pipeline to measure critical properties such as temperature and pressure of the flow product. The sensors are a combination of fiber optic sensing devices that are specifically designed to measure a range of properties within particular bandwidth, with a method to reduce light attenuation over the long pipeline distances. The pipeline is typically subsea and can range widely in diameter. In many cases the pipeline has a coating that acts as a barrier to the corrosive sea water and additional thermal barriers.

### CROSS REFERENCE TO RELATED APPLICATION

This application claims priority based on the Provisional Application No. 61/242,746, filed on Sep. 15, 2010, by David V. Brower, entitled: “An Apparatus to Monitor Flow Assurance Properties in Conduits,” which is incorporated by reference herein.

### BACKGROUND OF THE INVENTION

### Discussion of the Prior Art

The invention is directed to a device and methodology for measuring the flow assurance properties in conduits and pipeline that are used to transport oil and gas products. Pipelines that link wellhead s to a processing site are increasing in length. Many of these pipelines are deployed in subsea environments where water temperatures can cool the pipe that carries the hydrocarbon form the production well. As hot gases that flow from the well are subjected to cooling, hydrates can precipitate from the product and results in flow restrictions and in extreme cases can completely block the pipeline. In other instances slow buildup of paraffin wax on the interior of the pipeline can cause flow restrictions.

Typical measurements involve a combination of sensors that are strategically placed along the pipe to measure critical properties such a temperature and pressure of the flow product. In the past there has not been a convenient method for collecting the temperature and pressure flow of the product in the pipeline along the length of the pipeline. As these distances become greater, the difficulty has increased with respect to the collection of this information.

### SUMMARY OF THE INVENTION

The subject invention is directed to a method and apparatus for measuring the properties that can lead to flow assurance problems and, in addition, the method and apparatus for mitigating the cause for flow restriction in the pipeline.

The invention includes a combination of sensors that are strategically placed along the pipeline to measure critical properties such as temperature and pressure of the flow product. The sensors of the subject invention are a combination of fiber optic sensing devices that are specifically designed to measure a range of properties within particular bandwidth, with a method to reduce light attenuation over the long pipeline distances. The pipeline is typically subsea and can range widely in diameter. In many cases the pipeline has a coating that acts as a barrier to the corrosive sea water and additional thermal barriers.

The invention has the capability of monitoring very long pipeline lengths that could typically be on the order of 70 miles or more. Typically, the sensor portion of the subject invention will be installed before deployment of the pipeline. However, sensing stations can be installed post pipeline deployment where desired. The topside monitoring consists of data acquisition, signal conditioning, processing, display, alarms, and corrective action implementation. The topside monitoring typically resides in a control room and has the capability to be accessed offsite anywhere in the world via the Internet. The device can also alert operators automatically via cell phone in the event of any anomalous condition.

A method for monitoring the flow characteristics of hydrocarbons in a subsea pipeline comprising the steps of collecting hoop deflection data on the exterior pipelines via a series of fiber optic sensors located on the exterior of the pipeline and transmitting the collected hoop deflection data to a monitoring station for translating hoop deflection into pressure levels within the pipeline. The method may include the further step of placing a plurality of fiber optic sensors along the exterior of the pipeline for collecting the hoop deflection data along the length of the pipeline. The temperature of the interior of the pipeline is measured using the fiber optic sensors on the exterior of the pipeline in a non-invasive manner.

The pipeline monitoring system for monitoring the flow characteristics of hydrocarbons in a subsea pipeline utilizes fiber optic sensors mounted on the exterior wall of the subsea pipeline for collecting data. Cables are connected to each sensor for transmitting the collected data to a remote location. A collector connected to the cables is used for collecting the data from a plurality of sensors. A connector connected to the collector is used for transmitting the collected data to a remote location. The pressure in the pipeline is measured by the hoop stress on the exterior of the pipeline.

### BRIEF DESCRIPTION OF THE DRAWINGS

FIG. 1 is a perspective view of a typical pipeline, before deployment in a subsea environment.

FIG. 2 is a side view showing the fiber optic sensors as applied to the exterior wall of the pipeline.

FIG. 3 is a collector for collecting the data from a plurality of sensors attached to the pipeline.

FIG. 4 is an alternative collector for collecting the data from a plurality of sensors attached to the pipeline.

### DETAILED DESCRIPTION

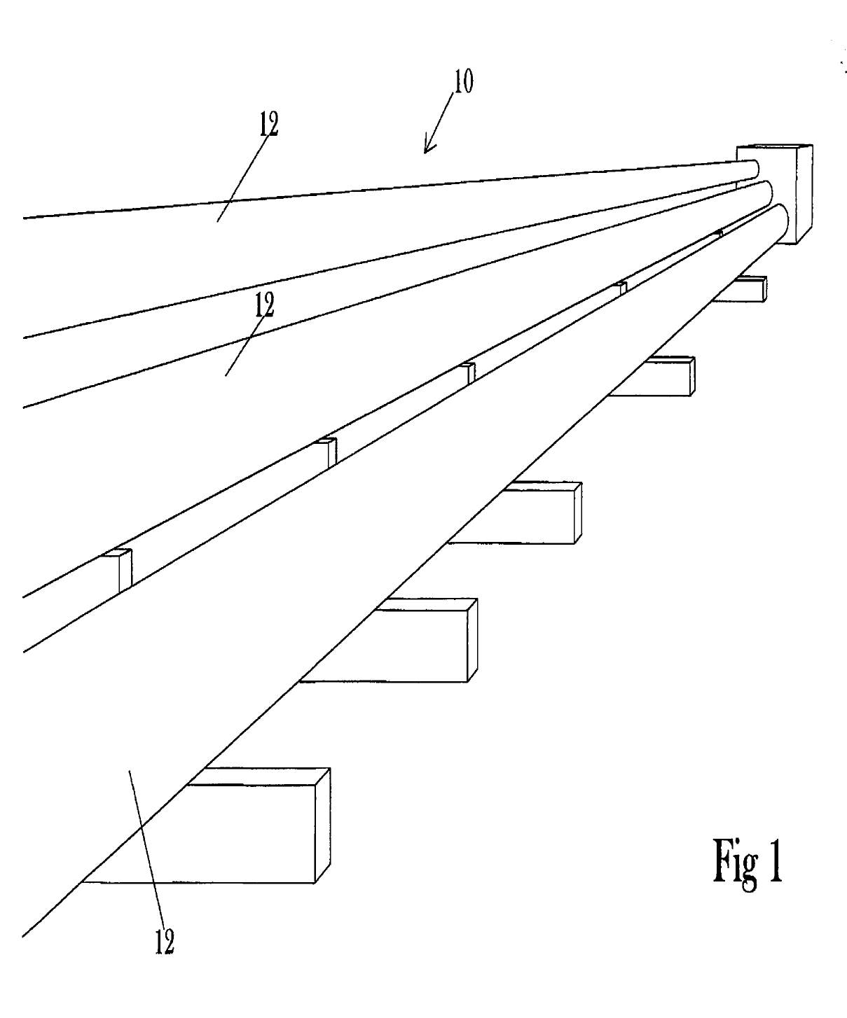

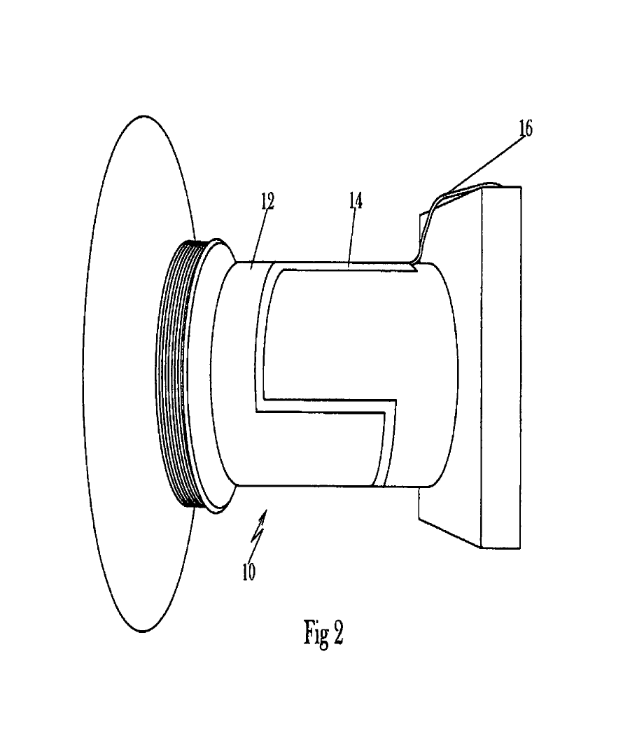

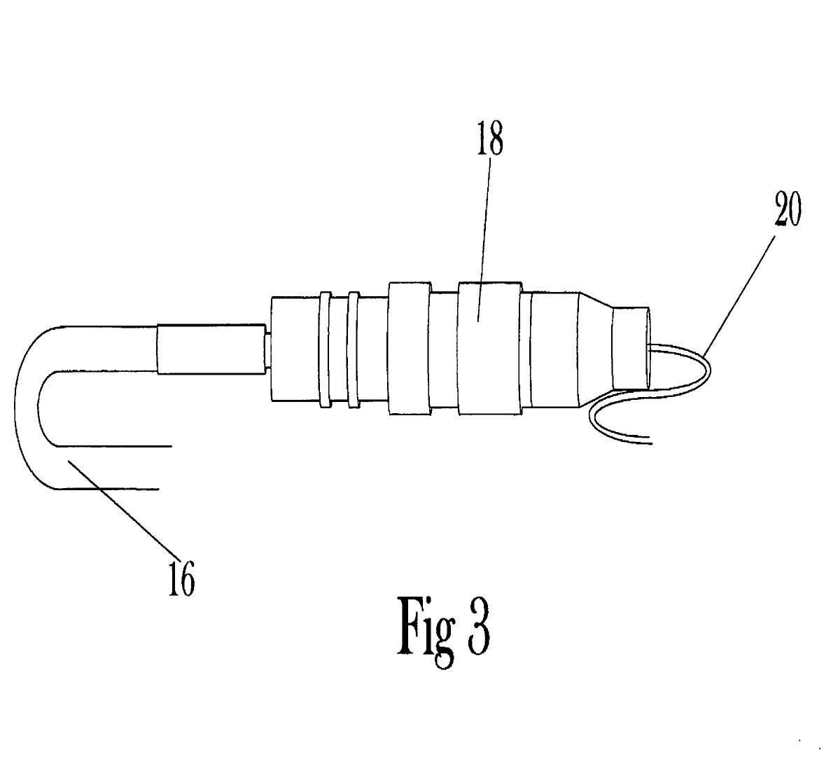

As shown in FIG. 1, a typical pipeline 10 is positioned for deployment in a subsea environment. In the preferred embodiment of the invention, the fiber optic sensors are attached directly to the outer wall 12 by an epoxy 14, as shown in FIG. 2. The data collected by a sensor array is then conducted to a fiber breakout assembly or collector 18 via the fiber optic cable 16, which is attached to the sensors in the array, see FIG. 3. The collected data is then conducted to a topside control room (not shown) via the conductor 20.

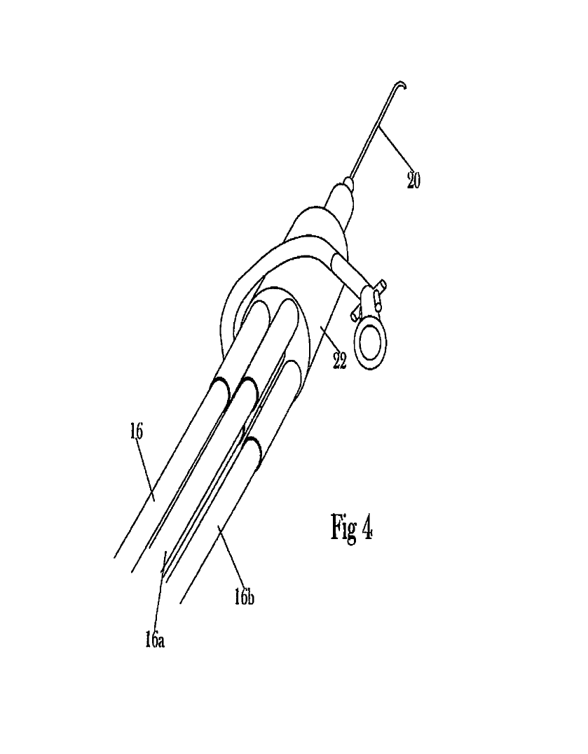

An alternative collector 22 is shown in FIG. 4, wherein a plurality of sensor array cables 16a-16e may be connected to a single collector 22 for transmitting the collected data to the topside control room via cable 20.

The cabling, connectors, breakout assemblies and support hardware are designed to provide ruggedness during installation and provide attenuation free light transfer. The system is designed for long service life and has measure incorporated to minimize any light transmittal issues such as fiber darkening from hydrogen infusion. Since there are various local measurement locations along the pipeline fiber breakout assemblies incorporated into the invention. Additionally, there is a combination of fiber optic measurements that are integrated into the system.

Preferably, the system contains a multiple of fiber Bragg grating arrays deployed subsea along the pipeline. The wavelength for the fiber Bragg gratings range from 1200 to 1700 nanometers. Reflectivity of greater than 10 percent is used with a typical range of greater than 90 percent preferred.

The fibers contain Germania dopants and are of a single mode mad of silica glass. All tubing is stainless steel.

Where desired, Kevlar jackets may be employed and Ebrium dopants can be used for amplification.

All coatings are preferably made of ployacrylate or polymide.

The time of flight for the light signal is incorporated in the topside monitoring system in the control room.

Attenuation mitigation is used by the use of a pressure balancing material applied to the fiber optic strands in the fiber optic cables. Preferably, the fiber optic cables are coated with a polyurethane, nylon, or polyethylene coating. Polyurethane and epoxy housings are used on top of the sensor stations.

The subsea sensors use hoop displacement of the pipeline the pipeline to determine product pressure from the exterior of the pipeline. No penetrations into the pipeline are necessary to gain access to the flow stream measurements. The connections are designed with a small angled ferrule to minimize back reflections.

Fiber bundles are multi-fused (more than one fusion splice) in each breakout assembly to reduce space requirements.

Optical time domain reflectrometry methods are integrated into fiber Bragg grating methods for temperature monitoring.

The data acquisition system claims power great than 20 dB within the interigator.

While certain embodiments and features of the invention have been described herein, it will be understood that the invention includes all modifications and enhancements within the scope and spirit of the following claims.

1. A method for monitoring the flow characteristics of hydrocarbons in a subsea pipeline comprising the steps of:
a. Collecting hoop deflection data on the exterior pipelines via a series of fiber optic sensors located on the exterior of the pipeline;
b. Transmitting the collected hoop deflection data to a monitoring station for translating hoop deflection into pressure levels within the pipeline.

2. The method of claim 1, further including the step of placing a plurality of fiber optic sensors along the exterior of the pipeline for collecting the hoop deflection data along the length of the pipeline.

3. The method of claim 1, further including measuring the temperature of the interior of the pipeline using the fiber optic sensors on the exterior of the pipeline in a non-invasive manner.

4. A pipeline monitoring system for monitoring the flow characteristics of hydrocarbons in a subsea pipeline comprising:
a. Fiber optic sensors mounted on the exterior wall of the subsea pipeline for collecting data;
b. Cables connected to each sensors for transmitting the collected data to a remote location;
c. A collector connected to the cables for collecting the data from a plurality of sensors. d. A connector connected to the collector for transmitting the collected data to a remote location.

5. The pipeline monitoring system of claim 4, wherein the pressure in the pipeline is measured by the hoop stress on the exterior of the pipeline.
